(19) United States
(12) Patent Application Publication
(10) Pub. No.: US 2005/0196488 A1
(43) Pub. Date: Sep. 8, 2005

(54) Dough conditioner

(76) Inventors: Yi Wu, Lafayette, LA (US); Antal G. Oszlanyi, Mooresville, NC (US); Azarel Nieves, Lafayette, LA (US)

Correspondence Address: Kean, Miller, Hawthorne, D'Armond,;McCowan & Jarman, L.L.P., P.O. Box 3513, Baton Rouge, LA, 70821, US

(21) Appl. No.: 11/074,510

(22) Filed: Mar. 7, 2005

Related U.S. Application Data
(63) Continuation-in-part of application No. 10/352,096, filed on Jan. 28, 2003, now abandoned.

(51) Int. Cl. A23L 1/10

(52) U.S. Cl. 426/18

(57) ABSTRACT

A dough conditioner comprising from about 0.05 wt. % to about 50 wt. % azodicarbonamide at least a fraction of which is microencapsulated; from about 0.1 to about 50 wt. % ascorbic acid; from about 0.01 to about 10 wt. % L-cysteine; from about 0.01 to about 10 wt. % fungal amylase; from about 0.1 to about 50 wt. % hemicellulose; from about 0.01 to about 10 wt. % lipase, all on a flour carrier and all weight percents based on the total weight of the dough conditioner excluding the weight of the flour carrier.

### CROSS REFERENCE TO RELATED APPLICATIONS

This is a continuation-in-part of U.S. Ser. No. 10/352,096 filed Jan. 28, 2003.

### FIELD OF THE INVENTION

The present invention relates to a dough conditioner and to a method of using the conditioner to improve bread quality.

### BACKGROUND OF THE INVENTION

Dough conditioners are complex mixtures containing various functional ingredients such as oxidizing and reducing agents (e.g. potassium bromate, cysteine), enzymes (e.g. .alpha.-amylase, hemicellulase), emulsifiers (e.g. DATEM-ester, stearic acids, SSL), fatty materials (e.g. fat, oil, lecithin) and carriers or bulk materials (starch, sugars, etc). Many of the commonly used dough conditioners contain oxidants, emulsifiers, and enzymes that are used for improving dough strength and crumb softness. Due to the generally low level of activity associated with these additives their usage generally requires the conditioner to be present at levels approaching 1-2% by weight of flour, where the flour component is defined as one-hundred percent (100%) and all other ingredients are measured relative to the flour weight. In addition, from the consumer's point of view, it is advantageous to minimize the use of emulsifiers and oxidants that are considered chemical additives.

The resistance of consumers to chemical additives is growing and there is therefore constant need to replace emulsifiers and oxidants by consumer friendly additives and/or enzymes that are considered as processing aids. Oxidizing agents provide strength to dough during the manufacturing process of yeast-leavened products. As a result, oxidizing agents are used to provide greater loaf volume, improve internal characteristics such as grain and texture, enhance symmetry and maintain quality of yeast-leavened products. The dough conditioner of this invention is a novel compounding of enzymes, oxidants, and sulfhydryl agent that functionally replaces the traditional additives. Adding the proper oxidation agents, along with the proper gluten modification agents results in a superior product with equal or superior functionality to conditioners presently in the marketplace. Furthermore, due to the novel activity of the invention the dough conditioner may be used at concentrations substantially lower than representative prior art concentrations for dough conditioners.

### SUMMARY OF THE INVENTION

An object of the invention is to provide an improved dough conditioner. The dough conditioner of the invention is a bromate-free product composed of a flour carrier and an enzyme preparation comprising amylase, hemicellulase, and lipase. In addition, the dough conditioner includes an oxidizing composition comprised of ascorbic acid (AA) and azodicarbonamide (ADA). The dough conditioner also contains a sulfhydryl agent, preferably L-cysteine, to act as a gluten softening agent. Due to its high degree of functionality, the dough conditioner of the present invention requires less than 0.2 parts dough conditioner per 100 parts flour. This dramatically lower usage results in a dramatic cost savings. For instance, conventional dough conditioners are typically used at 1-2% by weight flour. The product of this invention need only be used at levels less that about 0.2% by weight of flour to achieve dough of similar or superior quality. The conditioner of the present invention is remarkably versatile and capable of performing in a variety of baking methods without a noticeable difference in crumb structure or loaf volume.

Accordingly, it is an object of the present invention to provide an effective replacement for potassium bromate.

It is another object of the present invention to provide an oxidizing composition suitable for the preparation of a bromate-free dough composition and methods for its preparation.

It is a further object of the present invention to provide an oxidizing composition that acts as a slow acting oxidant functional throughout the entire manufacturing process.

It is a further object of the present invention to provide properly oxidized dough needed in the production of high quality, yeast-leavened products using ascorbic acid and azodicarbonamide as the only oxidizing agents combined with an enzyme preparation consisting of amylase, hemicellulase, and lipase.

It is a further object of the present invention to provide a dough conditioner capable of consistent performance in a variety of baking methods including a dough conditioner that functions equally well in hearth, pan breads, and pan rolls.

The present invention provides a dough conditioner which comprises at least one lipase, at least one hemicellulase and at least one amylase.

The present invention further provides a dough component which also contains flour, water, oil and yeast.

The dough of the invention may be baked to produce bread of improved quality and crumb structure.

The dough may further comprise a combination of mono-glycerides and organic oils, preferably 100 g or less per kilogram of flour, for example 15 to 50 g of solid soy oil and distilled mono-glycerides per kilogram of flour.

The resulting dough of the present invention may also contain one or more other non-limiting ingredients, such as salt, sugar, or other conventional dough ingredients.

The dough of the present invention is prepared without adding conventional emulsifiers such as diacetyl tartaric acid esters of mono- and diglycerides (DATEM-esters) and the sodium or calcium salt of stearic acids (SSL/CSL).

By achieving the objects in accordance with the purpose of the invention, the present invention overcomes many disadvantages of the prior art dough conditioners. The advantages of the dough conditioner composition of the present invention include:

(a) It is a slow acting oxidant that is functional throughout the entire manufacturing process.

(b) It is an effective oxidant that produces properly oxidized dough needed in the production of high quality, yeast-leavened products.

(c) It is specifically adapted for various methods of the breadmaking process and performs at a concentration between about 0.05 and about 0.15 parts by weight dough conditioner per 100 parts by weight flour.

(d) The use of the dough conditioner of the present invention is unexpectedly independent of the baking conditions, such as fermentation times, mixing times, baking times, temperatures, and the kind of dough product.

(e) The dough conditioner of the present invention can be used in a no-time straight-dough process and a sponge and dough process and works equally well in various dough systems including a Brew, Flour-Brew, and Short-Time dough processes. This unusual versatility of the conditioner of the present invention further demonstrates its utility in modern bakeries, where bakers can use a conditioner optimized for a particular baking method in many different baking processes. This one-size fits all conditioner of the present invention has heretofore not existed.

Furthermore, the dough conditioner composition of the present invention is a more effective oxidant than potassium bromate because potassium bromate has little effect on oxidation of dough during mixing and the early stages of proofing.

### DETAILED DESCRIPTION OF THE INVENTION

The manufacturing process of yeast-leavened products benefits from the effect of a dough conditioner in the mixing, molding, proofing, baking, and/or other stages of the process. The dough conditioner conditions the dough component. The dough component typically consists of all other ingredients other than the dough conditioner i.e., flour, water, yeast, sugar, salt, fat/emulsifier, etc. The combination of the dough conditioner and dough component is referred to as the dough composition or more simply as the dough.

Almost all dough conditioners contain one or more oxidizing agents. Oxidizing agents are similar in function in that they all strengthen dough, but each oxidizing agent has a different rate of reaction. For example, oxidizing agents such as potassium iodate, azodicarbonamide, and ascorbic acid are fast acting and mainly function during mixing and to a slight degree during proofing, but are largely dissipated during the later stages of proofing and the early stages of baking. On the other hand, potassium bromate is a slow acting oxidant and mainly functions during the later stages of proofing and the early stages of baking. Thus, the baker can combine fast and slow acting oxidants to provide adequate strengthening of dough throughout the entire manufacturing process. However, these combined oxidants have disadvantages because they become chemical additives, thereby requiring full labeling by complete chemical name. The present invention has advantages of using ascorbic acid and microencapsulated azodicarbonamide as the only oxidizing agents and providing adequate strengthening to the dough throughout the entire manufacturing process. Ascorbic acid use alone at high levels causes dough to become tight and eventually non-uniform demonstrating a gassy or bucky appearance. To improve the oven volume during the baking process, at least a fraction, preferably all, of the azodicarbonamide used in the present invention is microencapsulated and has an average particle size from about 50 to 1000 micrometer, preferably from about 75 to 800 micrometer and more preferably from about 100 to 600 micrometer. The microencapsulation delays the azodicarbonamide action converting it from a fast to a slow acting oxidizing agent.

Food and Drug Administration (FDA) regulations also limit the levels of all oxidizing agents permitted for use in yeast-leavened products, except ascorbic acid. For example, bromates and iodates should not exceed 75 ppm (parts per million) by weight of flour used in the formulation. Also, azodicarbonamide may be used in addition to bromates and iodates at a level of not more than 45 ppm. Currently, no limitation for ascorbic acid exists except “safe and suitable”, although previously this was specified as 200 wppm maximum. Thus, the present invention is particularly useful because it avoids the use of bromates and iodates while providing ascorbic acid along with azodicarbonamide as the only oxidizing agents. More importantly the oxidizing agents used in the present invention are effective and functional throughout the entire manufacturing process.

In order to allow ascorbic acid and azodicarbonamide to be functional during the early stage of baking, the oxidants can be microencapsulated with a food grade material, such as a high-melting point fat that will not melt until the baking stage has reached the adequate temperature in the oven. The oxidants can also be coated with 2 to 3% by weight edible cellulose to obtain longer shelf life during storage. Both microencapsulated and coated ascorbic acids and azodicarbonamide have disadvantages because they are not functional during the later stages of proofing. The present invention has the advantage of using oxidation agents combined with enzymes that are functional throughout the entire manufacturing process.

The only oxidizing agent approved in many parts of the world is ascorbic acid. Potassium bromate is a major oxidant used in the United States, although its use has been banned in the State of California and to a larger extent in Europe. Oxidizing agents that do not contain potassium bromate are now available to the baker in powdered and tablet forms. In addition to ascorbic acid and/or azodicarbonamide, potassium bromate replacers contain such things as calcium peroxide, L-cysteine, fungal enzymes, and other edible excipients. As more bakers are replacing potassium bromate with ascorbic acid, they are discovering that product quality suffers without the late acting oxidant. Continuously mixed and frozen doughs seem to have suffered the most. Thus, a need exists in the baking industry for an effective bromate replacer to produce high quality, yeast-leavened products. As a result, much effort has been directed to provide a combination of ingredients that replaces potassium bromate while serving as a highly functional dough conditioner.

The present invention addresses these issues by combining fast acting organic oxidants such as ascorbic acid with microencapsulated azodicarbonamide and enzymes to replace bromate conditioners. Studies on bread structure, loaf volume, and dough stickiness have indicated that overall bread quality improves by a dough conditioning approach which includes dough oxidants and enzymes.

Among the various dough conditioning enzymes, .alpha.-amylase is perhaps the most popular. .alpha.-Amylases partially degrade the starch fraction during baking and increase crumb softness. The amylase can increase the content of soluble sugars, and these can interact further with the components of the dough, e.g. water, amylose, amylopectin and protein. This may give other advantageous effects such as improved water distribution in the dough, improved keeping qualities at freezing, and improved ability to be heated in a microwave oven.

Dough containing wheat flour also contains soluble and insoluble hemicellulose (namely pentosan). Since solubility of pentosan exerts influence upon the rheology of dough, hemicellulase also exerts great influence upon the dough. Insoluble pentosan can exert an even greater influence upon dough, by effecting the dough stretching capacity. Since soluble pentosan has a strong ability to bind to water, it is useful in keeping the baked bread fresh for a prolonged period of time. The use of hemicellulases, particularly xylanases, in dough conditioners results in an improved oven spring during baking, an improved loaf volume, grain structure and better keeping quality of the baked product. However, the combined improvements imparted by amylases and hemicellulases are limited and therefore emulsifiers are still required for obtaining an acceptable keeping quality of bread when these enzymes are used alone.

Lipases are rarely used in bread improvers and detrimental effects have been observed from the action of endogenous lipase liberating unsaturated fatty acids into the dough.

The combined use of a hemicellulase, an amylase, preferably an α-amylase, a lipase and preferably shortening or oil has a complementary synergistic effect in such a way that loaf volume and crumb structure is clearly better than when each of the enzymes are used individually. The excellent crumb structure of bread obtained by addition of the enzyme preparation and shortening allows a significant reduction in emulsifiers without lowering the quality of the bread. Consequently, the amount of dough conditioner per kilogram of flour, or per kilogram of the dough component can be reduced.

In addition, to oxidants and enzymes it has been found that desirable results are obtained by introducing material having sulfhydryl activity (e.g., L-cysteine hydrochloride) which functions as a gluten softening agent. L-cysteine is a sulfur containing type reducing agent normally occurring in foods. As noted in U.S. Pat. No. 3,053,666 it has no detrimental effect on the flavor, nutritive value or other essential properties of the final baked product, and small amounts of L-cysteine (0.002-0.0025% by weight of flour) have been found to accelerate development of the dough to optimum consistency and to improve extensibility and maturity of the dough while processing to final baked goods.

The dough conditioner of the present invention is comprised of ascorbic acid, azodicarbonamide, L-cysteine, fungal amylase, hemicellulose and lipase on a flour carrier, preferably a wheat flour carrier. The dough conditioner, minus the flour carrier, comprises from about 0.05 wt. % to about 50 wt. %, preferably from about 0.5 to about 10 wt. % and more preferably from about 1 to about 4 wt. % azodicarbonamide; from about 0.1 to about 50 wt. %, preferably from about 0.5 to about 20 wt. % and more preferably from about 1 to about 10 wt. % ascorbic acid; from about 0.01 to about 10 wt. %, preferably from about 0.05 to about 5 wt. % and more preferably from about 0.1 to about 1 wt. % L-cysteine; from about 0.01 to about 10 wt. %, preferably from about 0.05 to about 5 wt. % and more preferably from about 0.1 to about 1 wt. % fungal amylase; from about 0.1 to about 50 wt. %, preferably from about 0.5 to about 20 wt. % and more preferably from about 1 to about 10 wt. % hemicellulose; and from about 0.01 to about 10 wt. % preferably from about 0.05 to about 5 wt. % and more preferably from about 1 to about 10 wt. % lipase; all based on the total weight of the dough conditioner.

The combination of the above ingredients has been found to perform equal to or superior than conventional bromate-free dough conditioners previously described. The present invention provides a dough conditioner of oxidants, enzymes and L-cysteine that works synergistically to produce an effective dough conditioner at concentrations significantly less than conventional dough conditioners. The dough conditioner of the present invention, when used in concentrations less than two-tenths of one percent based on the weight of flour, provides for lower transaction costs including storage, shipment, less scaling of dough conditioner, and lower costs per kilogram of flour, when compared to conventional dough conditioners.

The dough resulting from the use of the dough conditioner of present invention comprises from about 25-1250 FAU fungal amylase units (FAU) per kg flour, more preferably between about 75-250 FAU per kg flour. The amylase is generally fungal amylase for example from a strain of Aspergillus oryzae. The fungal amylase activity is measured at pH=5.5 and 30° C. using Phadebas tablets (Pharmacia) as a substrate and a fungal amylase preparation of 10,000 FAU/g as an internal reference [1 F(ungal) A(mylase) U(nit) is equivalent to 10 SKB-units].

In the present invention, hemicellulase is added preferably in an amount varying between about 25-500 β-xylanase units per kg flour, more preferably between about 35-280 β-xylanase units per kg flour. The hemicellulase is preferably fungal hemicellulase, for example from Aspergillus or Trichoderma strains. The hemicellulase activity is determined at pH=4.7 and 40° C. on a dyed xylan substrate (Xylazyme tablets from MegaZyme Inc. Australia). One β-xylanase unit is defined as the amount of enzyme required to release one micromole of xylose reducing equivalents per minute under the defined assay conditions.

According to the present invention lipase is preferably added in an amount varying between about 400-4000 lipase units per kg of flour, more preferably between about 800-2000 lipase units per kg of flour. One lipase unit is defined as the amount of enzyme required to liberate one micromole of fatty acid per minute under the defined assay conditions.

The lipase is preferably fungal lipase produced by a Rhizopus, Aspergillus, Candida, Penicillium or Mucor strain. Preferably a lipase from a strain of Rhizopus arrhizus or Rhizopus oryzae is used. The lipase activity is determined in a titrimetric test method at 37° C. and pH=6.0 using an oil in water emulsion of olive oil as a substrate.

The present invention will be further demonstrated by the following non-limiting examples, which demonstrates the use of the conditioner of the present invention in a no-time straight-dough process and a sponge and dough process. Other experiments have shown that the conditioner works equally well in a Brew, Flour-Brew, and Short-Time dough processes. This unusual versatility of the conditioner further demonstrates its utility in modern bakeries, where bakers may use a conditioner optimized for a particular baking method in many different baking processes. This one-size fits all conditioner has heretofore not existed. For example the addition rate will be same for the non-limiting types of doughs as shown in Table I below.

TABLE I

| Baking Application | Invention addition rate (%)* |
|---|---|
| No time Straight Dough | 0.063 to 0.125 |
| Standard Straight Dough | 0.063 to 0.125 |
| Sponge Dough | 0.063 to 0.125 |
| Liquid Sponge Dough | 0.063 to 0.125 |
| Frozen Dough | 0.063 to 0.125 |
| Brew Dough | 0.063 to 0.125 |
| Flour-Brew Dough | 0.063 to 0.125 |
| Short-Time Dough | 0.063 to 0.125 |

*% by weight flour

### EXAMPLE 1

Preparation of White Pan Bread (No-time Straight Dough Method) and Measurement of Crumb Physical Characteristics.

A bread dough was prepared having a dough component of 3500 g of flour (100 wt. %), 2310 ml water (66 wt. %), 105 g compressed yeast (3 wt. %), 140 g sugar (4 wt. %), 70 g salt (2 wt. %), 70 g soy oil (2 wt. %), 8.75 g Distilled Monoglycerides (0.25 wt. %), 70 g Non-Fat Dry Milk (2 wt. %), 8.75 g Calcium Proprionate (0.25 wt. %); and 4.375 g of the dough conditioner of the present invention (0.125%) containing an oxidizing composition of 105 mg ascorbic acid (100 ppm), 30 mg azodicarbonamide (45 ppm); 35 mg L-cysteine (10 ppm); and an enzyme preparation containing 35-280 xylanase units, 75-250 amylase units and 800-2000 lipase units. About 25 ppm of the 45 ppm azodicarbonamide was microencapsulated. The ingredients were mixed into a dough using a Kemper spiral mixer (350 rotations at speed 1 followed by 1200 rotations at speed 2).

Dough pieces of 900 g were rounded by hand, rested at ambient temperature for 5 minutes, punched, molded, panned, proofed for 65 minutes at 34° C. and baked for 30 minutes in an oven at 220° C.

Dough and baked products described in Example 1 were evaluated visually by observing dough stickiness and dough crumb structure. The physical characteristics of the baked products were determined as further described below.

Loaf specific volume: the volume of 20 loaves are measured using the traditional rape seed method. The common bromate/ascorbic acid conditioner containing 60-75 ppm bromate and 30 ppm ascorbic acid was used to establish a control loaf volume. The specific volume is calculated as volume (cc) per bread (g). The specific volume of the bromate/ascorbic acid control is defined as 100. The relative specific volume index is calculated as:
Specific Vol. Index=specific volume of 20 loaves/specific volume of 20 control loaves*100.

The dough stickiness and crumb structure are evaluated visually according to the following scale:

| | | |
|---|---|---|
| DOUGH STICKINESS: | almost liquid | 1 |
| | too sticky | 2 |
| | sticky | 3 |
| | normal | 4 |
| | dry | 5 |
| CRUMB STRUCTURE: | very poor | 1 |
| | poor | 2 |
| | non-uniform | 3 |
| | uniform/good | 4 |
| | very good | 5 |

Table II below shows the results of a baking test using two commercial dough conditioners and the conditioner of the present invention in a standard No-Time Straight Dough method. Conditioner 1 is formulated by Puratos Inc. and sold under the tradename US-500 and contains the ingredients: wheat flour, DATEM, L-Cysteine, ascorbic acid, potassium bromate, azodicarbonamide, and fungal enzymes. Conditioner 1 is used at 1-2% by weight flour. Conditioner 2 is formulated by Caravan Inc. and sold under the tradename IM-PROVE 200 and contains the following ingredients: wheat flour, DATEM, and 2 wt. % or less of ascorbic acid, azodicarbonamide, L-Cysteine, and fungal enzymes. Conditioner 2 is used at 1-2% by weight flour and contains the traditional oxidants potassium bromate and ascorbic acid. The results demonstrate that the addition of a combination of ascorbic acid, microencapsulate azodicarbonamide, L-cysteine, α-amylase, hemicellulase and lipase results in excellent bread quality and superior loaf volume at concentrations significantly less than commercial conditioners currently on the market. The crumb structure obtained with this combination is superior to or equal to the crumb structure obtained with other commercial conditioners. It is apparent, therefore, that excellent bread quality is obtained when using the present inventive dough conditioner in concentrations lower than previously used in the industry.

TABLE II

| | Conditioner 1 | Conditioner 2 | Invention |
|---|---|---|---|
| Amount used | 1.5 wt. % | 1.5 wt. % | 0.125 wt. % |
| Crumb Structure | 4.0 | 4.0 | 5.0 |
| Dough Stickiness | 4.0 | 4.0 | 4.0 |
| Loaf Volume (cc/g) | 5.40 | 5.01 | 5.90 |

### EXAMPLE 2

Preparation of White Pan Bread (Sponge and Dough Method) and Measurement of Crumb Physical Characteristics

A sponge-dough bread was prepared having a sponge component of 2100 g of wheat flour (60 wt. %), 831.6 ml water (36 wt. %), 105.0 g compressed yeast (3 wt. %), 8.8 g Yeast Food (0.25 wt. %); and 1.1 g of a dough conditioner of the present invention (0.031 wt. %) A dough component was prepared having 1400 g of wheat flour (40%), 1225 ml water (35%), 140 g sugar (4%), 70 g salt (2%), 70 g soy oil (2%), 8.75 g Distilled Monoglycerides (0.25%), 70 g Non-Fat Dry Milk (2%), 8.75 g Calcium Proprionate (0.25%), and 3.29 g of a dough conditioner of the present invention (0.09375%). The sponge ingredients were mixed into a dough using a Kemper spiral mixer (350 rotations at speed 1 followed by 1200 rotations at speed 2) for 2 to 3 minutes (Mix times will vary with the type of flour used). Fermentation temperatures ranged from 80° F. to 85° F. and 75% to 85% relative humidity. Fermentation times range from 3 to 5 hours. After fermentation the sponge and dough ingredients were mixed until smooth, dry and an extensible dough was acquired.

Dough pieces of 900 g were rounded by hand, rested at ambient temperature for 5 minutes, punched, molded, panned, proofed for 65 minutes at 34° C. and baked for 30 minutes in an oven at 220° C.

Dough and baked products described in Example 2 were evaluated visually as described above for Example 1 using the same control conditioner and commercial conditioners disclosed in Example 1.

TABLE III

| | Conditioner 1 | Conditioner 2 | Invention |
|---|---|---|---|
| Amount Used | 1.5 wt. % | 1.5 wt. % | 0.125 wt. % |
| Crumb structure | 3.0 | 3.0 | 5.0 |
| Dough Stickiness | 4.0 | 4.0 | 4.0 |
| Loaf Volume (cc/g) | 5.43 | 5.39 | 5.96 |

The data of Table III above shows, that in addition to the superior loaf volume achieved by the present invention, excellent crumb structure is retained regardless of the baking conditions. The performance of the other commercial conditioners, while adequate in the Straight-Dough method are not able to reproduce the crumb structure in the Sponge-Dough process. Because consumers favor bread products that display consistent qualities including loaf volume and crumb structure, the dough conditioner of the present invention is able to demonstrate greater utility in a modern bakery that is reluctant to use multiple conditioners optimized for specific baking processes.

### EXAMPLE 3

Preparation of Hearth Bead and Measurement of Crumb Physical Characteristics.

A hearth bread was prepared using 650 g flour (100 wt. %), 370.5 g water (57 wt. %), 13 g yeast (2 wt. %), 13 g salt (2 wt. %), 13 g sugar (2 wt. %), 13 g oil (2 wt. %) and either the dough conditioner in the present invention (addition rate: 0.125%) or a dough improver similar to that shown in U.S. Pat. No. 6,251,444, which does not contain any ADA but does contain the followings: 19 mg ascorbic acid (29.23 wppm), 13 g L-cysteine (20 wppm), 234 mg amylase (36 wppm), 27.3 mg hemicellulose (42 wppm) and 162.5 mg lipase (250 wppm).

| | Dough Improver | Present Invention |
|---|---|---|
| Crumb Structure | 3.0 | 4.5 |
| Dough Stickiness | 4.0 | 4.0 |
| Loaf Volume (cc/g) | 5.01 | 6.49 |

Table IV below shows the baking results of the two hearth breads. The hearth bread using the conditioner in the present invention had better crumb structure and loaf volume.

While the invention has been described in detail and with reference to specific examples thereof, it will be apparent to one skilled in the art that various changes and modifications can be made therein.

1. A dough conditioner comprising from about 0.05 wt. % to about 50 wt. % azodicarbonamide at least a fraction of which is microencapsulated; from about 0.1 to about 50 wt. % ascorbic acid; from about 0.01 to about 10 wt. % L-cysteine; from about 0.01 to about 10 wt. % fungal amylase; from about 0.1 to about 50 wt. % hemicellulose; from about 0.01 to about 10 wt. % lipase, all on a flour carrier and all weight percents based on the total weight of the dough conditioner excluding the weight of the flour carrier.

2. The dough conditioner of claim 1 wherein the amount of azodicarbonamide is from about 0.5 to about 10 wt. %.

3. The dough conditioner of claim 1 wherein the amount of ascorbic acid is from about 0.5 to about 20 wt. %.

4. The dough conditioner of claim 1 wherein the amount of L-cysteine is from about 0.05 to about 5 weight percent.

5. The dough conditioner of claim 1 wherein the amount of fungal amylase is from about 0.05 to 5 wt. %.

6. The dough conditioner of claim 1 wherein the about of hemicellulase is from about 0.5 to about 20 wt. %.

7. The dough conditioner of claim 1 wherein the amount of lipase is from about 0.05 to about 5 wt. %.

8. A dough composition, comprising: a) a flour based dough component; and b) from about 0.05 to about 0.2 parts by weight per 100 parts by weight of dough component, of a dough conditioner, comprising: from about 0.05 wt. % to about 50 wt. % azodicarbonamide at least a fraction of which is microencapsulated; from about 0.1 to about 50 wt. % ascorbic acid; from about 0.01 to about 10 wt. % L-cysteine; fungal amylase in an amount from about 25 to about 1250 fungal amylase units per kilogram of flour; hemicellulose in an amount from about 25 to about 500 β-xylanase units per kilogram of flour; and lipase in the amount of about 400 to about 4000 lipase units per kilogram of flour.

9. The dough conditioner of claim 8 wherein the amount of azodicarbonamide is from about 0.5 to about 10 wt. %.

10. The dough conditioner of claim 8 wherein the amount of ascorbic acid is from about 0.5 to about 20 wt. %.

11. The dough conditioner of claim 8 wherein the amount of L-cysteine is from about 0.05 to about 5 weight percent.

12. A method for improving rheological properties of a flour dough and the quality of the resulting baked product produced therefrom which comprises combining flour, yeast and water and up to about 0.2 wt. % of a dough conditioner comprised of from about 0.05 wt. % to about 50 wt. % azodicarbonamide at least a fraction of which is microencapsulated; from about 0.1 to about 50 wt. % ascorbic acid; from about 0.01 to about 10 wt. % L-cysteine; from about 0.01 to about 10 wt. % fungal amylase; from about 0.1 to about 50 wt. % hemicellulose; from about 0.01 to about 10 wt. % lipase, all on a flour carrier and all weight percents based on the total weight of the dough conditioner excluding the weight of the flour carrier; and mixing the ingredients to form a suitable baking dough.

13. The dough conditioner of claim 12 wherein the amount of azodicarbonamide is from about 0.5 to about 10 wt. %.

14. The dough conditioner of claim 12 wherein the amount of ascorbic acid is from about 0.5 to about 20 wt. %.

15. The dough conditioner of claim 12 wherein the amount of L-cysteine is from about 0.05 to about 5 weight percent.

16. The method in accordance with claim 12 wherein said dough is prepared by means of a straight dough process.

17. The method in accordance with claim 12 wherein said dough is prepared by means of the sponge and dough process.

18. The method in accordance with clam 14 wherein said final baked product is bread.

19. The method in accordance with claim 14 wherein the resulting baked product contains sweetening or sweetening agents.

20. The method in accordance with claim 12, wherein the resulting baked product contains distilled mono-glycerides.
